(19) United States
(12) Patent Application Publication
(10) Pub. No.: US 2004/0046072 A1
(43) Pub. Date: Mar. 11, 2004

(54) Horizontal fan nozzle

(76) Inventor: Ernest Joseph Kois, Boulder, CO (US)

Correspondence Address: The Law Office of Craig W. Barber, PO Box 16220, Golden, CO, 80402-6004, US

(21) Appl. No.: 10/232,359

(22) Filed: Aug. 31, 2002

(51) Int. Cl. B05B 3/00

(52) U.S. Cl. 239/726

(57) ABSTRACT

The present invention provides a vehicle mounted fan nozzle for use with agricultural vehicles, deicers for roads and airports, and other vehicles which need to spray a swath wider than the width of the vehicle. The present invention provides a vehicle mounted fan nozzle for use with a threaded pipe section, the nozzle comprising: a generally tubular body having a long axis, and having an open end and a closed end, and having an interior conduit and a longitudinal surface; the open end being threaded, the threaded end being dimensioned and configured so as to engage such threaded pipe section; a plurality of compact apertures along a portion of the longitudinal surface of the body; each of the compact apertures forming a passageway from the interior conduit to the longitudinal surface; an extended arcuate aperture having a first end located at the closed end of the body, the first end extending from the interior conduit to the closed end of the body; the extended arcuate aperture having a second end located at the longitudinal surface of the body, the second end extending from the interior conduit to the longitudinal surface of the body. In another embodiment the nozzle comprises a semi-circular beveled surface located at the junction of the longitudinal surface of the body and the closed end of the body, the beveled surface being bisected by the extended arcuate aperture.

### FIELD OF THE INVENTION

This invention relates generally to vehicle mounted fan nozzles and specifically to vehicle mounted fan nozzles for agricultural or de-icing applications.

### BACKGROUND OF THE INVENTION

Vehicle mounted fan nozzles are customarily used for several different types of applications. These applications share certain problems in common, for example, the volume of the nozzle must be carefully selected and controlled, because unlike an immobile nozzle, the volume of liquid discharge cannot be controlled strictly on the basis of time of use of the nozzle: a vehicular nozzle must discharge a set amount of liquid evenly and quickly so that the vehicle can continue moving at the highest possible speed. By contrast, an immobile nozzle may simply be turned on and off at such times as provide the proper amount of coverage of the area being doused.

Vehicular mounted nozzles also usually serve to disperse relatively expensive liquids such as deicers (airport deicer may cost upwards of $9/gallon), pesticides, fertilizers and so on. For this reason also, a carefully controlled and very even discharge is required.

One typical application of vehicular nozzles is for deicing. Road crews, airport workers and others apply deicing compounds to roads, runways, parking lots and similar surfaces by driving a vehicle having fan nozzles mounted thereon along the surface. While other types of nozzles may advantageously drop deicing compound directly in the path of the vehicle (in the front, the rear or underneath the vehicle), fan nozzles are needed in order to spread the deicing compound out laterally to one or both sides of the vehicle. In the case of a vehicle traveling down a multilane road and spreading deicer, the ability to spread the deicer to more than one lane greatly reduces the number of times that the vehicle must traverse the road in order to deice the entire surface in comparison to a vehicle spreading deicer on only one lane at a time.

In the case of an airport runway, the width of the runway is normally a multiple of the width of the typical ground vehicle. A vehicle only ten feet wide would need fifteen passes to cover a runway 150 feet wide completely. On the other hand, a vehicle having the ability to cover a thirty feet wide strip requires only five passes, thus saving approximately 67% of the energy requirement in the form of vehicle fuel. This principal applies to any type of vehicle: truck, aircraft, farm tractor, and most applications.

In the case of a state, local, municipal or other Department of Transportation spray truck, the normal de-icing of a roadway is the width of the vehicle, that is, one 12 foot wide lane or less. A horizontal fan nozzle may give such a vehicle the ability to spray an additional width up to 41 feet on each side of the vehicle. Thus resources such as: fuel, energy, time, labor costs, and wear and tear are saved by a factor of three: three times the coverage means that a given amount of coverage requires only one third of the resources. The same multiple of three in coverage (or reduction to one third of resources) applies to agricultural and other use as well. For example in agricultural use, vehicle mounted fan nozzles allow a vehicle to cover in a single pass a width much larger than the vehicle's own width, allowing for reduced soil compaction and in turn requiring less tillage of the ground.

Thus a vehicle mounted fan nozzle may be profitably employed in savings of fuel, energy and related factors such as equipment use and labor requirements.

Various known types of vehicle mounted fan nozzles exist.

U.S. Pat. No. 2,778,688, issued Jan. 22, 1957, to C. S. Corl, for SPRAYING APPARATUS teaches a vehicular spraying apparatus a single orifice nozzle.

U.S. Pat. No. 2,964,248, issued Dec. 13, 1960, to E. J. O'Brien et al, for PLURAL ORIFICE FAN SHAPED SPRAY NOZZLE teaches a nozzle having two fan orifices but no jet orifices.

U.S. Pat. No. 2,971,250, issued to F. W. Wahlin, on Feb. 14, 1961, for SPRAY NOZZLE WITH CONTOURED ORIFICE AND METHOD OF CONTOURING THE ORIFICE teaches a nozzle having an elongated and contoured orifice. There is only one orifice.

U.S. Pat. No. 4,161,280, issued Jul. 17, 1979, to Kasinskas, for METHOD AND APPARATUS FOR DISPENSING A DEICER FLUID teaches a plurality of straight nozzles without any fan type nozzle. The nozzles may be offset sideway in order to change the footprint of each nozzle's dispersion, but there is no teaching of actual broadcast significantly beyond the width of the vehicle.

U.S. Pat. No. 4,648,558, issued Mar. 10, 1987, to Rabitsch, for SPRINKLER ASSEMBLY teaches an entire sprinkler assembly which is not apparently suitable for vehicular usage and thus is non-analogous art. The nozzle of the sprinkler has a U-shaped passageway with a diffuser blade projecting upwards thereinto. The blade may be moveable or fixed. There is no bottom to the passageway.

U.S. Pat. No. 4,848,670, issued Jul. 18, 1989, to Belanger et al, for NOZZLE CONSTRUCTION teaches a non-analogous air nozzle for drying of vehicles as they pass through a car wash. The air nozzle has a plurality of elongated apertures but does not apparently teach any fan effect.

U.S. Pat. No. 4,898,330, issued Feb. 6, 1990, to Betchan, for PORTABLE DEICER SPRAYER teaches a human-portable sprayer, but does not teach significant details of the nozzle.

U.S. Pat. No. 5,076,497, issued Dec. 31, 1991, to Rabitsch, for SPRAY NOZZLE teaches a vehicle mounted fan nozzle having a discharge passageway with a U-shaped cross-section and a curved-blade diffuser within the end portion of the passageway. The passageway has only side walls and a top but there is no bottom wall. The nozzle is made up of several components which must be assembled: a polymer insert diffuser, a polymer threaded end, and a cast and machine formed metal channel into which the diffuser is inserted and which is in turn screwed into the polymer end, which serves as an adapter from the size of the nozzle outlet to the size of the pipe or hose feeding it. The result is an expensive product which retails for a high price under the tradename BOOM BUSTER. It is believed to be difficult or impossible to make this item in cheaper materials due to flexion in the side walls of the channel.

U.S. Pat. No. 5,447,272, issued Sep. 5, 1995, to Ask, for AUTOMATIC DICER SPREADER teaches a stationary deicer spreader for granular or liquid spreader. The nozzle used may include a tube with a pattern of holes to allow exit of the deicer.

U.S. Pat. No. 5,878,964, issued Mar. 9, 1999, to Hansen, for SPRAY NOZZLE WITH TWO OR MORE EQUALLY SIZED ORIFICES teaches a stationary sprinkler having multiple orifices; the design of the sprinkler is such that range is not dependent upon flow volume.

U.S. Pat. No. 5,911,363, issued Jun. 15, 1999, to Oligschlaeger, for VEHICLE MOUNTED SPRAY APPARATUS AND METHOD teaches a variable flow nozzle having a needle valve/nozzle which provides a solid flow of liquid to a single point. A spring is mounted within the nozzle.

U.S. Pat. No. 5,964,410, issued Oct. 12, 1999, to Brown et al, for METHOD AND APPARATUS OF UNIFORM NOZZLE LIQUID APPLICATION BY WAY OF VEHICLE teaches a single flow nozzle having a spring mounted within the nozzle.

U.S. Pat. No. 5,979,799, issued Nov. 9, 1999, to Chen et al, for FEED NOZZLE teaches a feeding steam and heavy petrochemicals into a reactor: a non-analogous use. The nozzle uses either slit apertures or lines of circular apertures.

U.S. Pat. No. 6,082,638, issued Jul. 4, 2000, to Ask et al, for ANTI-ICING NOZZLE MOUNTING DEVICE teaches an adjustable nozzle arrangement from the non-analogous stationary nozzle art: the nozzles are apparently mounted on, in or near the surface to be sprayed on a permanent basis.

Finally, retailing under the tradename HYPRO there is a multiple component nozzle which has a threaded end with a nut. In general configuration it is much like the nozzle of the '497 patent, however, having a liquid conduit of narrow diameter which projects well into the U-shaped channel. A collar holds the generally U-shaped channel and the conduit to the threaded end; the channel is open from proximate end to distal end (much like the channel of the '497 patent, sans diffuser) and has a modest narrowing at the distal end. A needle valve or conduit with a greatly narrowed inner diameter projects from the threaded end substantially into the channel, an O-ring assists in sealing the conduit to the threaded end. In practice, water flows through the threaded end into the conduit and thence exits into the channel at a medial point substantially up the channel from the proximate end thereof. The water then flows both directions in the channel, towards distal and proximate ends, while exiting the U-shaped channel. That nozzle has no compact apertures, is a multiple component construction (due to the presence of exterior ribs to add strength, the channel may be plastic, but the remainder of the construction is metal) and lacks a semi-circular beveled surface. It has a high retail price.

In general, known vehicle nozzle tend to either spray a single flow to a single point or do not provide an adequate fan-type distribution of the liquid. Other nozzles cannot be manufactured in single pieces, in low-cost materials, or lack a combination of compact and extended apertures.

It would be advantageous to save energy and fuel and time by the use of a fan nozzle providing excellent coverage without high costs. It would further be beneficial if such a fan nozzle, in addition to saving fuel, minimized losses of the liquid being dispensed.

### SUMMARY OF THE INVENTION

General Summary

The present invention teaches a single piece vehicle mounted fan nozzle having an arcuate aperture located at the end of the nozzle and a series of compact apertures located longitudinally along a portion of the length of the nozzle. A semi-circular bevel at the end of a generally cylindrical body provides an excellent fan and a good distribution of the water.

The nozzle of the invention offers an excellent throwing range, however, the nozzle may also be made of a single piece of material such as plastic or another polymer, thus dramatically reducing construction costs without reducing utility.

The nozzle of the present invention furthermore features a valve body preventing the loss of the fluids in the nozzle.

Use of the present invention's nozzle saves energy and fuel and time while providing excellent coverage without high costs. The fan nozzle, in addition to saving fuel minimizes losses of the liquid being dispensed.

Summary in Reference to Claims

It is one aspect, advantage, embodiment and objective of the present invention to provide a vehicle mounted fan nozzle for use with a pipe section, the nozzle comprising: a generally tubular body having a long axis, and having an open end and a closed end, and having an interior conduit and a longitudinal surface; the open end having a connector thereon, the connector being dimensioned and configured to engage with the pipe section; a plurality of compact apertures along a portion of the longitudinal surface of the body; each of the compact apertures forming a passageway from the interior conduit to the longitudinal surface; at least one extended aperture having a first end located at the closed end of the body, the first end extending from the interior conduit to the closed end of the body; the extended aperture having a second end located at the longitudinal surface of the body, the second end extending from the interior conduit to the longitudinal surface of the body.

It is another aspect, advantage, embodiment and objective of the present invention to provide a nozzle wherein such pipe is threaded and the nozzle further comprising threads on such open end, the thread being dimensioned and configured so as to engage such threaded pipe section.

It is another aspect, advantage, embodiment and objective of the present invention to provide a nozzle wherein such pipe has at least one levered cam; the nozzle further comprising a groove dimensioned and configured so as to engage such cam when such cam is in a first position.

It is another aspect, advantage, embodiment and objective of the present invention to provide a nozzle further comprising: a semi-circular beveled surface located at the junction of the longitudinal surface of the body and the closed end of the body, the beveled surface being bisected by the extended aperture.

It is another aspect, advantage, embodiment and objective of the present invention to provide a nozzle wherein each of the plurality of compact apertures are set at a radial angle to the second end of the aperture.

It is another aspect, advantage, embodiment and objective of the present invention to provide a nozzle wherein each of the radial angles of the compact apertures are in the range from approximately 0 to approximately 45 degrees.

It is another aspect, advantage, embodiment and objective of the present invention to provide a nozzle wherein each of the plurality of compact apertures are set at a longitudinal angle to the long axis.

It is another aspect, advantage, embodiment and objective of the present invention to provide a nozzle wherein each of the longitudinal angles of the compact apertures are in the range from approximately 90 degrees to approximately 45 degrees.

It is another aspect, advantage, embodiment and objective of the present invention to provide a nozzle further comprising: a portion forming a nut.

It is another aspect, advantage, embodiment and objective of the present invention to provide a nozzle wherein the threaded open end is threaded externally to form a male attachment.

It is another aspect, advantage, embodiment and objective of the present invention to provide a nozzle wherein the threaded open end is threaded internally to form a female attachment.

It is another aspect, advantage, embodiment and objective of the present invention to provide a nozzle wherein the entire nozzle is manufactured from a single piece of material.

It is another aspect, advantage, embodiment and objective of the present invention to provide a nozzle wherein the single piece of material is selected from the group consisting of: plastic, rubber, other polymeric materials, wood, metal, carbon composite and combinations thereof.

It is another aspect, advantage, embodiment and objective of the present invention to provide a nozzle for use with a threaded pipe section, the nozzle comprising: a generally tubular body having a long axis, and having an open end and a closed end, and having an interior conduit and a longitudinal surface; the open end being threaded, the thread being dimensioned and configured so as to engage such threaded pipe section; a plurality of compact apertures along a portion of the longitudinal surface of the body; each of the compact apertures forming a passageway from the interior conduit to the longitudinal surface; at least one extended aperture having a first end located at the closed end of the body, the first end extending from the interior conduit to the closed end of the body; the extended aperture having a second end located at the longitudinal surface of the body, the second end extending from the interior conduit to the longitudinal surface of the body; a valve having a first position such that it obstructs water flow through the conduit and a second position such that it allows water flow through the conduit; a spring attached to the valve so as to urge the valve into the first position; an adjustment means whereby the spring may be tensioned so as to urge the valve into the first position when there is no imposed pressure on the liquid, and further so as to allow the valve into the second position when pressure is imposed on the liquid.

### BRIEF DESCRIPTION OF THE DRAWINGS

FIG. 1 is a top view of the first embodiment of the nozzle of the present invention.

FIG. 2 is an end view of the first embodiment of the nozzle of the present invention.

FIG. 3 is a cross-sectional view along section line A-A of FIG. 2 of the first embodiment of the nozzle of the present invention.

FIG. 4 is a partially cross-sectional perspective view of the second embodiment of the nozzle of the present invention.

FIG. 5 is a cross-sectional view of the second embodiment of the nozzle of the present invention.

### DETAILED DESCRIPTION

The present invention teaches a vehicle mounted fan nozzle offering a long range, a uniform distribution, and inexpensive construction.

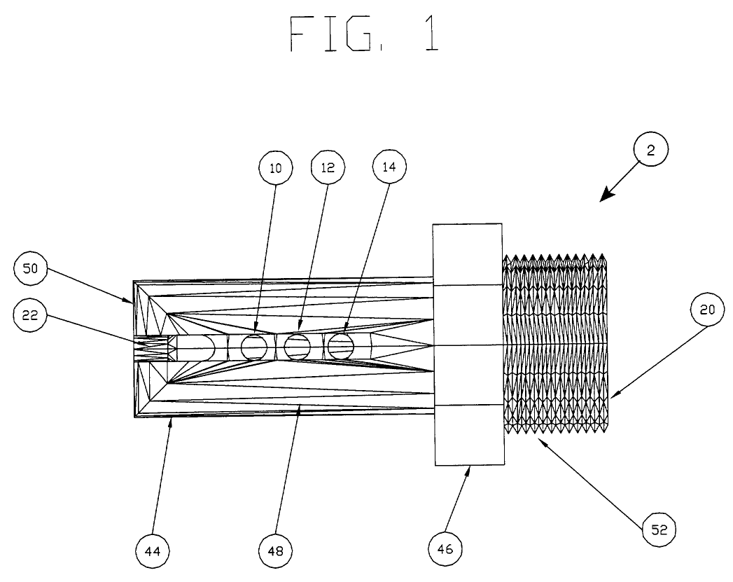

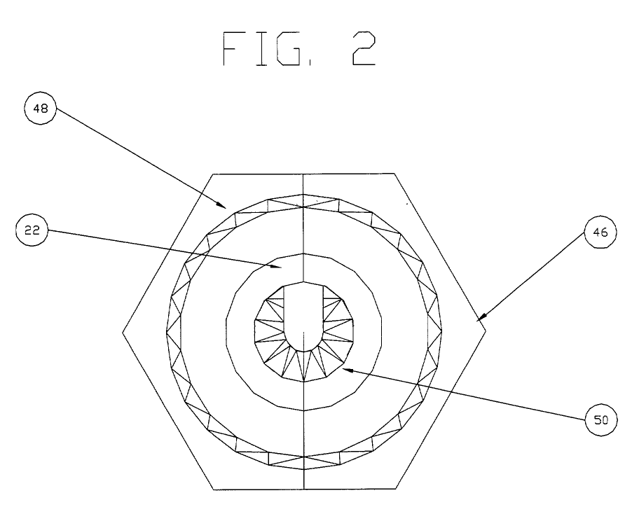

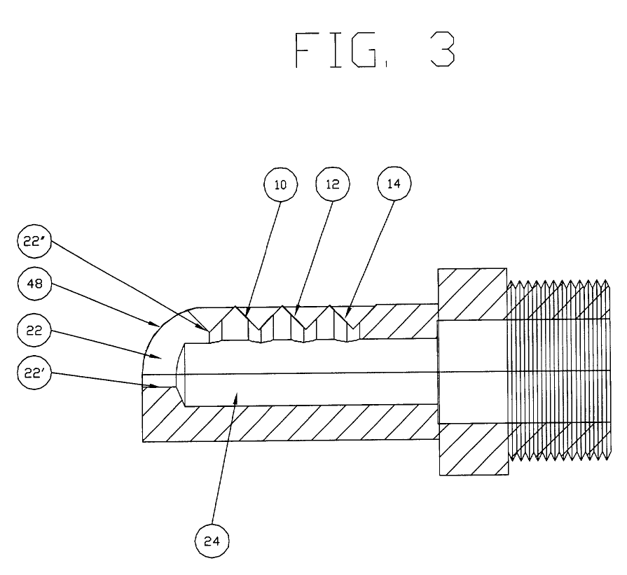

FIG. 1 is a top view of the first embodiment of the nozzle of the present invention. Nozzle 2 has open end 20 having threads 52. Nozzle 2 has a body which is generally tubular. In the preferred embodiment, nozzle 2 is of a generally cylindrical cross-section (a tube having a circular cross section) but in other embodiments, nozzle 2 may have a tubular body which is a square cross section, a polygonal tubular cross section or other shapes. Nozzle 2 has a long axis extending generally from end to end, however, in other less preferred embodiments, the long axis may in fact be shorter than the cross sectional diameter of the body. Nozzle 2 also has closed end 50, nut 46, shaft 44 and longitudinal surface 48 on the exterior of nozzle 2. Compact apertures 10, 12 and 14 are visible, as is extended aperture 22. FIG. 2 is an end view of the first embodiment of the nozzle of the present invention, with section line A-A. FIG. 3 is a cross-sectional view along section line A-A of FIG. 2 of the first embodiment of the nozzle of the present invention. In this view, interior conduit 24 is visible. Interior conduit 24 is open at open end 20 and closed at closed end 50 except for the opening offered by extended aperture 22.

Open end 20 is threaded with threads 52, which may be SAE, metric or other standard or non-standard sizes as long as these threads are dimensioned and configured so as to engage a threaded pipe section to which nozzle 2 is to be attached. Open end 20 and threads 52 may comprise a male or female attachment.

In alternative embodiments of the invention, threads 52 may be replaced by a cam connector and groove in which a grooved male member on the nozzle fits within a female member having levered cams: after insertion, the levers are rotated and the cams forced into firm engagement with the groove, thus securing the nozzle to the pipe. Other alternative embodiments use other alternative connection means without departing from the scope of the invention.

The cross-sectional diameter of nozzle 2 may be selected so as to provide the appropriate range and liquid flow. In various preferred embodiments, conduit diameters from ⅛ inch (3.175 mm) up to 2 inches (50.8 mm) are contemplated, although in less preferred embodiments larger and smaller diameters may be used. In various preferred embodiments, body diameters from ¼ inch (3.175 mm) up to 3 inches (50.8 mm) are contemplated, although in less preferred embodiments larger and smaller diameters may be used. In preferred embodiments, the length of nozzle 2 may range from 1 inch (25.4 mm) up to 6 inches (152.4 mm), however in less preferred embodiments larger and smaller diameters may be used. In general, the desirable control over flow rate (liquid volume/minute) may most advantageously be controlled by controlling the cross sectional diameter of the interior conduit (discussed with reference to FIG. 3), and the length and diameter of nozzle 2 will depend upon this value.

Note that nozzle 2 may have different diameters at different longitudinal locations, and different cross sections. For example, it is desirable that the diameter of threaded portion 52 of open end 20 should match the diameter of the hose/connection to which it is to be connected, should be of the same thread pitch and depth and so on. Nozzle 2 may be manufactured in a variety of such sizes, pitches, depths and so on so as to allow connection to any of a variety of hoses.

Compact apertures 10, 12, 14 may be more or less numerous than the three shown in the preferred embodiment and best mode presently contemplated for carrying out the invention. While the presently preferred embodiment utilizes apertures in a single straight line, they may also be in another arrangement: rows, staggered, irregular and so on. The apertures may be beveled at the exterior as shown in FIGS. 1 and 3 or may be straight, and may be circular as shown for the preferred embodiment or may be other compact shapes in less preferred embodiments. In general, circular compact apertures are preferred simply for ease of manufacture.

Extended aperture 22 is defined by ends 22′ and 22″. It will be readily apparent that the ends of the extended aperture 22 allow it to extend from closed end 50 around to the “side” of shaft 44, that is, longitudinal surface 48. Since one end 22′ of extended aperture 22 is located along interior conduit 24 while the other end 22″ is located on longitudinal surface 48, extended aperture 22 will function to provide a spray of liquid which fans around from the side of nozzle 2 (generally in line with the sprays issuing from the compact apertures 10, 12 and 14) to a portion of the spray which sprays almost straight out from the nozzle along the axis of conduit 24.

This combination of a plurality of compact apertures and a single extended aperture is believed to provide the easy to manufacture and inexpensive device of the present invention with performance comparable to much more expensive and complex prior art nozzles.

Nut 46 may be any convenient and standard shape and size allowing such tools as are standard in the field to be employed in installing and removing nozzle 2. For example, in one preferred embodiment, the nut may be a 1.5 inch (approximately 38 mm) hex nut. In other embodiments, it may be other even sizes and may be a square nut or other standard shape.

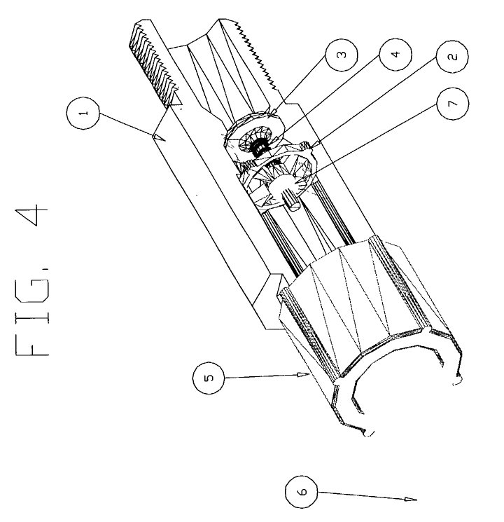

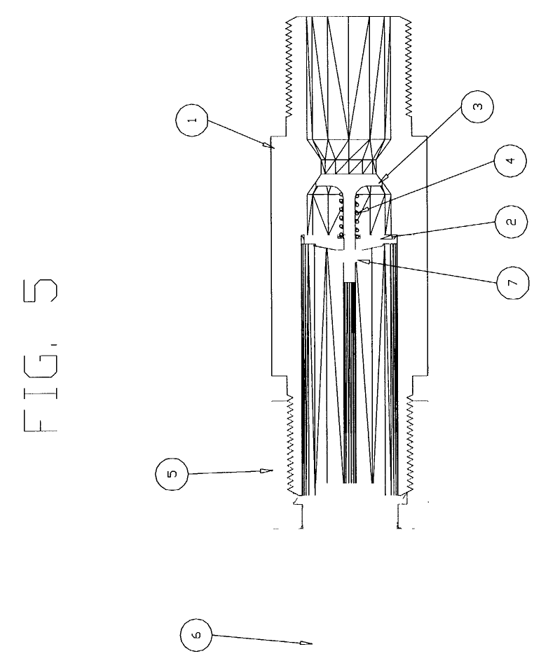

FIG. 4 is a partially cross-sectional perspective view of the second embodiment of the nozzle of the present invention. FIG. 5 is a cross-sectional view of the second embodiment of the nozzle of the present invention. In this embodiment of the invention, a check valve is installed to prevent excess fluid loss. As discussed previously, fluids such as deicer and fertilizer can be very expensive. Every time the vehicle pump stops operating, a certain amount of fluid is left in the hoses, pipes or other connectors leading from the pump down to the nozzles. The liquid volume left may be a gallon (3.8 liters) or more. As the vehicle departs the area it has finished treating and prepares to begin another sweep at a slightly different location the liquid left in the hoses, etc, will dribble out under the influence of gravity, falling on areas which the operator did not wish to treat. For example, as a farm tractor is turning around at the end of a field in order to spray a new swath across a field, some fertilizer or pesticide or other liquid may drip out onto the area at the end of the field, beyond the end of the furrows or rows of crops. Merely turning off the pump, of course, cannot prevent this loss. The typical work situation will involve multiple “runs” and thus multiple losses of liquid in the volume of the pipes. In addition, when the pump is turned on again at the start of the next swath to be treated, the empty hoses will not provide liquid for a moment, until they are refilled.

Nozzle 6 of this embodiment has rotatable collar type female connector 5 which connects to a male connector (not visible in FIG. 4) of valve body 1. Within the conduit of valve body 1, valve 3 is urged by spring 4 to close the conduit and thus prevent fluid flow. Valve 1 or in the alternative, a ball valve, is held in place by tab 2 which slides down grooves inside of the conduit: when valve 1 is correctly positioned, tab 2 may be rotated and locked into place in a position no longer in line with the grooves. Thereafter, flow down the conduit will no longer push tab 2 up the conduit. Nut 7 may hold tab 2 in place on valve 3.

In use, flow pressure against valve 3 will cause it to open against the urging of spring 4 and liquid will flow. At the end of use, spring 4 will once again automatically close valve 3, preventing flow of liquid from the pipes upstream of valve body 1.

In an alternative embodiment, the nozzle has the same components as nozzle 2 of the first embodiment, and a ball type check valve assembly as well. The ball/valve ball/ball valve is attached to the spring inside of the conduit and thence to a rod. The threads of the valve assembly allow easy connection to a hose. The rod is threaded and fits through the body of valve assembly (which has corresponding threads) to the exterior, so that the tension of the spring may be adjusted merely by rotating the rod where it protrudes from the valve assembly. When not in use, no pressure is present and the spring urges the ball/valve against the valve assembly, preventing the flow of fluid. In a first position, the valve ball thus prevents flow of fluid under the influence of gravity.

In use, when the vehicle pump (not shown) is turned on, the pressure will force fluid through the conduit and against the valve ball. The valve/ball will be forced into a second position away from the valve assembly, allowing fluid flow.

In general, fluid flow rate is a function of vehicle speed, width to cover per pass, desired volume per area coverage and other related factors including liquid pressure and volume of flow per minute or hour.

Tests of the nozzle (without valve assembly) were carried out independently to compare the performance of the nozzle of the invention with the performance of the nozzle of the '497 patent.

Comparative Test One

The nozzle of the invention and the nozzle of the '497 patent were tested at a work height of 48 inches (approximately 122 cm), work angle of 0 degrees from vertical. The nozzle of the '497 patent used a ⅜″ coupling (approximately 9.5 mm) while the nozzle of the present invention used a ¼″ (6.35 mm) coupling. The nozzle of the '497 patent was tested at 35 PSI pressure while the nozzle of the present invention was tested at only 20 PSI, thus providing a theoretical flow rate handicap for the reference nozzle. In practice, a lower pressure is desirable as allowing less expensive tubing, connections, pumps, and other ancillary equipment. The lower pressure is also desirable to minimize wear and tear on the same equipment.

The nozzle of the present invention was manufactured from Acctron Rod GB NST with a 2 inch diameter, and was substantially as shown in FIG. 1, having three compact apertures and one extended aperture running for the side of the nozzle to the closed end around a semicircular beveled section. The nozzle of the '497 reference was purchased commercially, and comprised a forged/machined metal U-shaped passageway with a diffuser insert of a first polymer and a threaded open end of a second polymer. The inexpensive manufacture of the invention compared favorably with the high price of the prior art reference nozzle.

Flow rate is an important value for fan nozzles: the greater the flow rate, the faster the vehicle may cover a given swath, thus saving application time. The two nozzles were tested to find out how long it took to provide a total flow of 4 gallons.

| FLOW RATE TEST | INVENTION NOZZLE | '497 NOZZLE |
|---|---|---|
| time in seconds, 4 gallons | 33.12 | 57.47 |

The invention thus provides a greater flow rate, even at a lower pressure and used with a smaller coupling.

Comparative Test Two

Under the same conditions as the first test, the nozzles were tested for total volume at a given range from the nozzle. Instead of measuring the time necessary to achieve a set volume, a line of water receptacles (buckets having a 9 inch (228.6 mm) diameter) were passed through the flow three times and the total volume of water in each measured. Each receptacle thus corresponds to the coverage of a 9 inch wide swath laterally 9 inches further away from the nozzle than the preceding swath.

| RECEPTACLE # | INVENTION NOZZLE, ml | '497 NOZZLE, ml |
|---|---|---|
| 1 | 13 | 30 |
| 2 | 44 | 44 |
| 3 | 101 | 39 |
| 4 | 146 | 41 |
| 5 | 171 | 42 |
| 6 | 116 | 41 |
| 7 | 91 | 43 |
| 8 | 52 | 50 |
| 9 | 164 | 56 |
| 10 | 158 | 59 |
| 11 | 158 | 67 |
| 12 | 200 | 73 |
| 13 | 220 | 79 |
| 14 | 250 | 89 |
| 15 | 280 | 97 |
| 16 | 250 | 100 |
| 17 | 200 | 119 |
| 18 | 186 | 127 |
| 19 | 167 | 139 |
| 20 | 150 | 135 |
| 21 | 124 | 100 |
| 22 | 89 | 88 |
| 23 | 57 | 87 |
| 24 | 30 | 81 |
| 25 | 10 | 65 |
| 26 | 4 | 36 |
| 27 | 0 | 17 |
| 28 | 0 | 5 |
| 29 | 0 | 0 |

Thus it can be seen that over most of the range of the nozzle of the present invention, the flow compares favorably with that of the '497 reference nozzle, despite lower pressure and smaller diameter.

Comparative Test Three

The test conditions were the same as previously described, however, the work height was 18 inches (approximately 46 cm), the reduced work height in turn altering the profile of the water flow across distance.

The first 5 swaths differed markedly. Both nozzles started with very low flow at the first receptacle/swath. The nozzle of the '497 reference slowly built to a value of under 50 ml at the 6^{th} swath, while the nozzle of the invention exhibited a marked hump up to almost 300 ml at the 5^{th} swath, then fell to a value comparable to that of the reference nozzle at the 6^{th} swath. Thereafter, both nozzles exhibited a relatively stable coverage profile out to roughly the 20^{th} swath, after which the flow rate of the nozzle of the invention fell away to almost no flow at the 22^{nd} swath, while the nozzle of the '497 reference fell away to almost no flow at the 25^{th} swath.

Thus, at short range the nozzle of the invention exhibits markedly larger flow than that of the reference, while at long range the nozzle of the invention exhibits slightly lower flow. In the large middle range from the 6^{th} to the 20^{th} swaths, the two devices exhibit almost identical flow rate.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A vehicle mounted fan nozzle for use with a pipe section, the nozzle comprising:
a) a generally tubular body having a long axis, and having an open end and a closed end, and having an interior conduit and a longitudinal surface;
b) the open end having a connector thereon, the connector being dimensioned and configured to engage with the pipe section;
c) a plurality of compact apertures along a portion of the longitudinal surface of the body; each of the compact apertures forming a passageway from the interior conduit to the longitudinal surface;
d) at least one extended aperture having a first end located at the closed end of the body, the first end extending from the interior conduit to the closed end of the body; the extended aperture having a second end located at the longitudinal surface of the body, the second end extending from the interior conduit to the longitudinal surface of the body.

2. The nozzle of claim 1, wherein such pipe is threaded and the nozzle further comprising threads on such open end, the thread being dimensioned and configured so as to engage such threaded pipe section.

3. The nozzle of claim 1, wherein such pipe has at least one levered cam; the nozzle further comprising a groove dimensioned and configured so as to engage such cam when such cam is in a first position.

4. The nozzle of claim 1, further comprising:
a semi-circular beveled surface located at the junction of the longitudinal surface of the body and the closed end of the body, the beveled surface being bisected by the extended aperture.

5. The nozzle of claim 1, wherein each of the plurality of compact apertures are set at a radial angle to the second end of the aperture.

6. The nozzle of claim 5, wherein each of the radial angles of the compact apertures are in the range from approximately 0 to approximately 45 degrees.

7. The nozzle of claim 1, wherein each of the plurality of compact apertures are set at a longitudinal angle to the long axis.

8. The nozzle of claim 7, wherein each of the longitudinal angles of the compact apertures are in the range from approximately 90 degrees to approximately 45 degrees.

9. The nozzle of claim 1, further comprising:
e) a portion forming a nut.

10. The nozzle of claim 1, wherein the threaded open end is threaded externally to form a male attachment.

11. The nozzle of claim 1, wherein the threaded open end is threaded internally to form a female attachment.

12. The nozzle of claim 1, wherein the entire nozzle is manufactured from a single piece of material.

13. The nozzle of claim 10, wherein the single piece of material is selected from the group consisting of: plastic, rubber, other polymeric materials, wood, metal, carbon composite and combinations thereof.

14. A vehicle mounted fan nozzle for use with a threaded pipe section, the nozzle comprising:
a) a generally tubular body having a long axis, and having an open end and a closed end, and having an interior conduit and a longitudinal surface;
b) the open end being threaded, the thread being dimensioned and configured so as to engage such threaded pipe section;
c) a plurality of compact apertures along a portion of the longitudinal surface of the body; each of the compact apertures forming a passageway from the interior conduit to the longitudinal surface;
d) at least one extended aperture having a first end located at the closed end of the body, the first end extending from the interior conduit to the closed end of the body; the extended aperture having a second end located at the longitudinal surface of the body, the second end extending from the interior conduit to the longitudinal surface of the body;
e) a valve having a first position such that it obstructs water flow through the conduit and a second position such that it allows water flow through the conduit;
f) a spring attached to the valve so as to urge the valve into the first position;
g) an adjustment means whereby the spring may be tensioned so as to urge the valve into the first position when there is no imposed pressure on the liquid, and further so as to allow the valve into the second position when pressure is imposed on the liquid.
